(19) United States
(12) Patent Application Publication
(10) Pub. No.: US 2019/0287033 A1
(43) Pub. Date: Sep. 19, 2019

(54) INFORMATION PROCESSING SYSTEM, INFORMATION PROCESSING DEVICE, AND INFORMATION PROCESSING METHOD

(71) Applicant: Yuuta HASHIMOTO, Tokyo (JP)

(72) Inventor: Yuuta HASHIMOTO, Tokyo (JP)

(73) Assignee: Ricoh Company, Ltd., Tokyo (JP)

(21) Appl. No.: 16/351,964

(22) Filed: Mar. 13, 2019

(30) Foreign Application Priority Data
Mar. 19, 2018 (JP) 2018-051825
Jan. 16, 2019 (JP) 2019-005561

(51) Int. Cl. G06Q 10/02; H04W 4/80

(52) U.S. Cl. CPC G06Q 10/02; H04W 4/80

(57) ABSTRACT

An information processing device includes a processor configured to execute: receiving facility information, which contains identification information enabling facility identification, using first-type communication from a transmitter, which is installed in a facility for which a reservation for use is to be made and which performs continuous or intermittent transmission of the facility information; sending the facility information using the first-type communication, to a server device using second-type communication; receiving reservation status information sent by the server device in response to transmission of the facility information and which indicates time slot in which a reservation is possible for facility specified in the facility information; controlling display of the reservation status information, in a display unit; and sending reservation information, which indicates a reserved time slot selected based on the reservation status information, to the server device using the second-type communication, and making a reservation for desired time slot of desired facility.

### CROSS-REFERENCE TO RELATED APPLICATIONS

The present application claims priority under 35 U.S.C. § 119 to Japanese Patent Application No. 2018-051825, filed on Mar. 19, 2018 and Japanese Patent Application No. 2019-005561, filed on Jan. 16, 2019. The contents of which are incorporated herein by reference in their entirety.

### BACKGROUND OF THE INVENTION

### 1. Field of the Invention

The present invention relates to an information processing system, an information processing device, and an information processing method.

### 2. Description of the Related Art

In Japanese Unexamined Patent Application Publication No. 2008-152540, a reservation management system is disclosed that is intended to enable making a reservation of a plurality of facilities or equipment with ease or to enable making changes in the reservation or confirming the reservation with ease. In that reservation management system, a reservation of the desired facility and the desired time slot can be made by obtaining a list of the reservation status of available facilities from a server device and by sending the desired date and time for reservation to the server device.

However, in the reservation management system disclosed in Japanese Unexamined Patent Application Publication No. 2008-152540, it is difficult to perform a reservation operation with respect to the facilities present close to the current location of the user.

The present invention has been made in view of the issue mentioned above, and it is an object of the present invention to provide an information processing system, an information processing device, and a computer program product that enable performing a reservation operation with respect to the facilities present close to the current location of the user.

### SUMMARY OF THE INVENTION

According to an embodiment, an information processing device includes a processor. The processor is configured to execute: receiving facility information, which at least contains identification information enabling facility identification, using first-type communication from a transmitter, which is installed in a facility for which a reservation for use is to be made and which performs continuous transmission or intermittent transmission of the facility information; sending the facility information, which is received using the first-type communication, to a server device using second-type communication that is different than the first-type communication; receiving reservation status information which is sent by the server device in response to transmission of the facility information and which indicates time slot in which a reservation is possible for facility specified in the facility information; controlling display of the reservation status information, which is received from the server device, in a display unit; and sending reservation information, which indicates a reserved time slot that is selected based on the reservation status information, to the server device using the second-type communication, and accordingly making a reservation for desired time slot of desired facility.

### BRIEF DESCRIPTION OF THE DRAWINGS

FIG. 1 is a diagram illustrating a brief overview of a reservation processing system according to a first embodiment;

FIG. 2 is a block diagram of transmitters installed in the reservation processing system according to the first embodiment;

FIG. 3 is a block diagram of a handheld device used in the reservation processing system according to the first embodiment;

FIG. 4 is a block diagram of a server device installed the reservation processing system according to the first embodiment;

FIG. 5 is a functional block diagram of the transmitters, the handheld device, and the server device in the reservation processing system according to the first embodiment;

FIG. 6 is a sequence diagram for explaining an operation of registering facility information in the reservation processing system according to the first embodiment;

FIG. 7 is a diagram illustrating an example of a registration screen meant for registering facility information;

FIG. 8 is a diagram illustrating an example of registered facility information;

FIG. 9 is a sequence diagram for explaining a reservation operation meant for making a reservation of a conference room in the reservation processing system according to the first embodiment;

FIG. 10 is a diagram illustrating an example of a usage registration screen in the reservation processing system according to the first embodiment;

FIGS. 11A and 11B are diagrams illustrating examples of data indicating the usage status of each conference room as registered in the server device in the reservation processing system according to the first embodiment;

FIG. 12 is a sequence diagram for explaining a reservation operation performed as a modification example of the reservation processing system according to the first embodiment;

FIG. 13 is a diagram illustrating a functional block diagram of transmitters, a handheld device, a server device, and an administrator PC in a reservation processing system according to a second embodiment;

FIG. 14 is a sequence diagram for explaining a user registration operation for authentication purposes in the reservation processing system according to the second embodiment;

FIG. 15 is a diagram illustrating an example of a user registration screen in the reservation processing system according to the second embodiment;

FIG. 16 is a diagram illustrating a condition in which each conference room is registered in a corresponding manner to user information of the users who are allowed to use that conference room in the reservation processing system according to the second embodiment;

FIG. 17 is a sequence diagram for explaining a reservation operation in the reservation processing system according to the second embodiment; and

FIG. 18 is a diagram illustrating an example of data indicating the usage status of each conference room as registered in the server device in the reservation processing system according to the second embodiment.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

Exemplary embodiments of a reservation processing system in which an information processing system, an information processing device, and an information processing method are implemented are described below.

### First Embodiment

Brief Overview

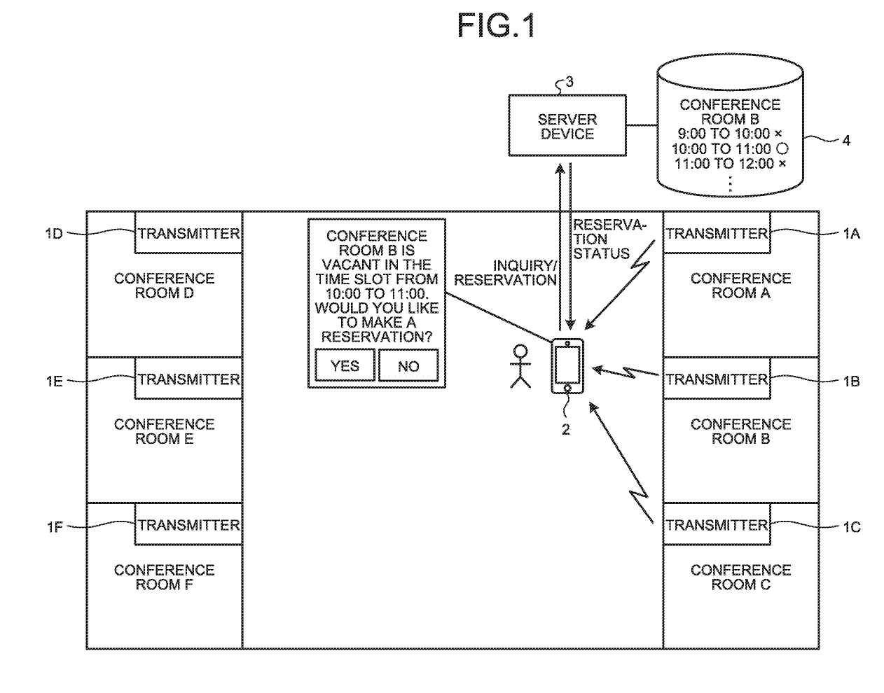

FIG. 1 is a diagram illustrating a brief overview of a reservation processing system according to a first embodiment. Although only exemplary, in the reservation processing system illustrated in FIG. 1 according to the first embodiment, from among six conference rooms starting from a conference room A to a conference room F provided on the floors of a building, a user selects a conference room that is vacant in the desired time slot.

For example, close to the entrance of the conference rooms A to F, transmitters 1A to 1F are respectively installed for the purpose of performing continuous broadcast or intermittent broadcast of facility information, which at least contains the information enabling facility identification, based on a near field communication protocol such as the BLE communication protocol (BLE stands for Bluetooth (registered trademark) Low Energy). As the facility information, for example, it is possible to use the conference room name and the reservation status. Alternatively, it is possible to use information enabling identification of the “name” of the facility. Still alternatively, it is possible to use a number enabling a server device 3 to uniquely identify the facility such as a conference room, or it is possible to use a combination of a number enabling identification of the building and a unique identification number for the conference room present in the building.

In a handheld device 2 of a user, based on a reservation application program (a reservation application) installed in advance, from among the radio waves received at the current location from the transmitters 1A to 1F, sets of facility information having the radio field strength equal to or greater than a predetermined threshold value are received and are listed in a display unit of the handheld device 2.

Based on the sets of facility information listed in the display unit of the handheld device 2, the user selects the desired conference room and checks the reservation status of the desired conference room by performing network communication, such as Wi-Fi (registered trademark) communication, with the server device 3 that is installed in a predetermined network, such as a local area network (LAN).

The server device 3 includes a usage status database (a reservation status DB) 4 in which the usage status of each of the conference rooms A to F is stored. The reservation status information about the conference rooms A to F as stored in the reservation status DB 4 of the server device 3 is updated on a steady basis. When a request for checking the reservation status of the desired conference room is received from the handheld device 2 of the user, the server device 3 sends the reservation status information of the requested conference room to the handheld device 2 of the user.

The user checks the reservation status of the desired conference room as sent from the server device 3; selects vacant time slots; and makes a reservation for using the conference room in the server device 3 by operating the handheld device 2. Upon receiving the reservation from the user, the server device 3 updates the reservation status information in the memory unit. That completes the reservation for the use of the desired conference room in the desired time slots.

In this reservation processing system, the sets of facility information that are transmitted from the nearby locations of the current location of the user are received using near field communication. Hence, the reservation for the use of a facility can be made by narrowing down the facilities, such as conference rooms or gymnasiums, that are close to the current location of the user.

Hardware Configuration According to First Embodiment

Hardware Configuration of Transmitters

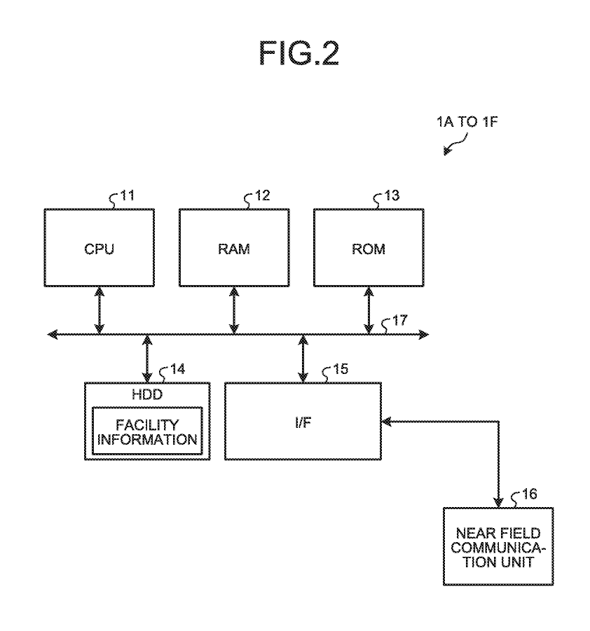

FIG. 2 is a diagram illustrating a hardware configuration of the transmitters 1A to 1F. As illustrated in FIG. 2, each of the transmitters 1A to 1F includes a central processing unit (CPU) 11, a random access memory (RAM) 12, a read only memory (ROM) 13, a hard disk drive (HDD) 14, and an interface (I/F) 15 that are connected to each other via a bus line 17. To the I/F 15 is connected a near field communication unit 16 that broadcasts facility information using near field communication such as the BLE communication protocol.

The CPU 11 controls the overall operations. The RAM 12 is a volatile memory medium with respect to which reading and writing of information can be performed at high speeds, and is used as the work area at the time when the CPU 11 performs information processing. The ROM 13 is a non-volatile memory medium used as a read-only memory, and is used to store computer programs such as firmware. The HDD 14 is a non-volatile memory medium with respect to which reading and writing of information can be performed, and is used to store an operating system (OS), various control programs, various application programs, and facility information to be broadcast.

Hardware Configuration of Handheld Device

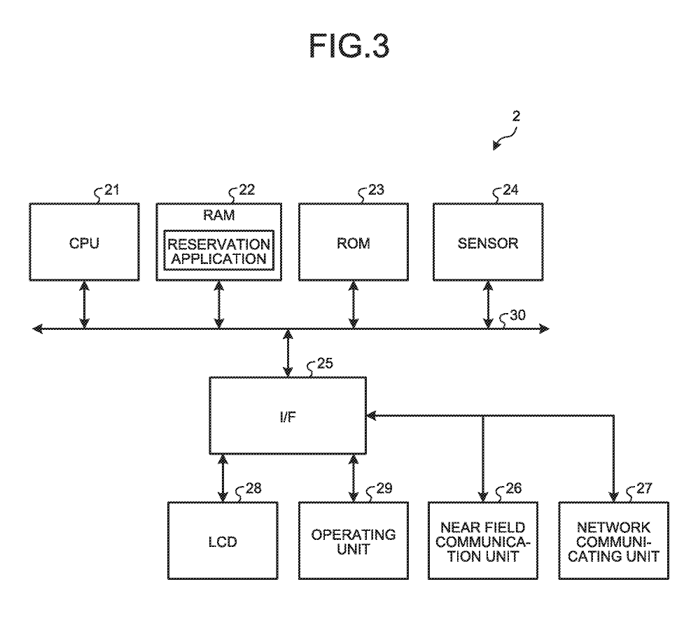

FIG. 3 is a diagram illustrating a hardware configuration of the handheld device 2. As illustrated in FIG. 3, the handheld device 2 includes a CPU 21, a RAM 22, a ROM 23, a sensor 24, and an interface (I/F) 25 that are connected to each other via a bus line 30. To the I/F 25 is connected a near field communication unit 26 that receives facility information broadcast from the transmitters 1A to 1F using near field communication such as the BLE communication protocol. Moreover, to the I/F 25 is connected a network communication unit 27 that performs communication with a server device 3 using network communication such as Wi-Fi (registered trademark) communication. Furthermore, to the I/F 25 are connected a liquid crystal display (LCD) 28 and an operating unit 29.

The CPU 21 controls the overall operations. The RAM 22 is a volatile memory medium with respect to which reading and writing of information can be performed at high speeds, and is used as the work area at the time when the CPU 21 performs information processing. Moreover, the RAM 22 is used to store the reservation application program (the reservation application) (described later). The CPU 21 executes the reservation application and performs a reservation operation for making a reservation of the desired facility such as a conference room.

The ROM 23 is a non-volatile memory medium used as a read-only memory, and is used to store an operating system (OS), various control programs, various application programs, and computer programs such as firmware. The I/F 25 establishes and controls connection of the bus line 30 with a variety of hardware and networks.

The liquid crystal display 28 is, for example, a visual user interface equipped with a touch-sensitive panel, and enables implementation of a keyboard using software. The operating unit 29 represents hardware keys such as a power key and menu keys. The sensor 24 includes an interface for sound recognition enabling collection of the surrounding sounds.

Hardware Configuration of Server Device

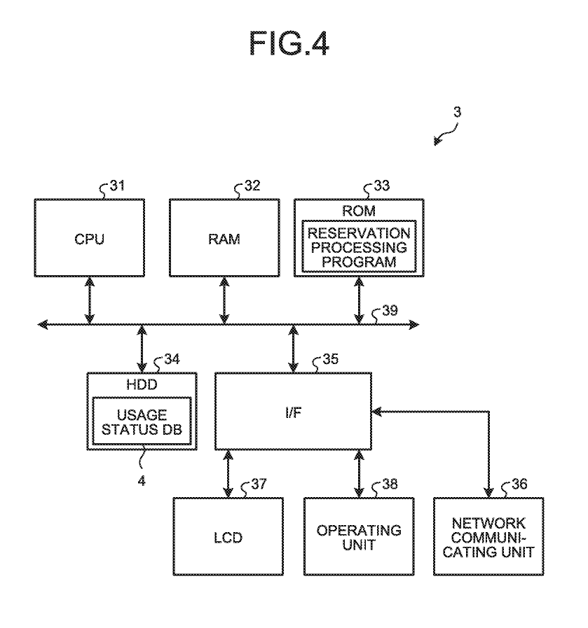

FIG. 4 is a diagram illustrating a hardware configuration of the server device 3. As illustrated in FIG. 4, the server device 3 includes a CPU 31, a RAM 32, a ROM 33, an HDD 34, and an interface (I/F) 35 that are connected to each other via a bus line 39. To the I/F 25 is connected a network communicating unit 36 that performs network communication such as Wi-Fi communication with the handheld device 2.

The CPU 31 controls the overall operations. The RAM 32 is a volatile memory medium with respect to which reading and writing of information can be performed at high speeds, and is used as the work area at the time when the CPU 31 performs information processing. The ROM 33 is a non-volatile memory medium used as a read-only memory, and is used to store an operating system (OS), various control programs, firmware, and a reservation processing program meant for performing a reservation operation for making a reservation of the conference rooms A to F.

The HDD 34 is a non-volatile memory medium with respect to which reading and writing of information can be performed, and is used to store reservation status information in the memory corresponding to the reservation status DB 4. The I/F 35 establishes and controls connection of the bus line 39 with a variety of hardware and networks. A liquid crystal display 37 is, for example, a visual user interface equipped with a touch-sensitive panel, and enables implementation of a keyboard using software. An operating unit 38 is a user interface such as a keyboard or a mouse that enables the user to perform input operations.

Software Configuration of Reservation Processing System

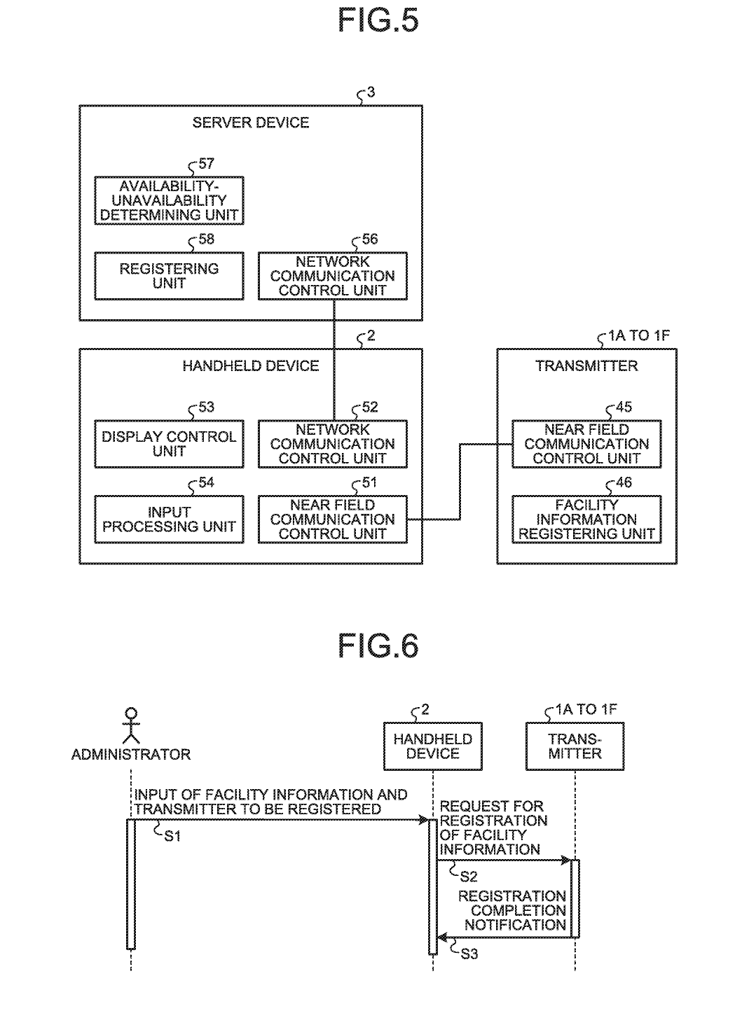

In FIG. 5, following functional blocks are illustrated: functional blocks of the functions implemented when the CPU 11 of each of the transmitters 1A to 1F executes a near field communication program; functional blocks of the functions implemented when the CPU 21 of the handheld device 2 executes the reservation application; and functional blocks of the functions implemented when the server device 3 executes the reservation processing program.

Functions of Transmitters

The transmitters 1A to 1F are installed in the conference rooms or at the entrance of the conference rooms in such a way that, when a user comes close for the purpose of receiving facility information, the facility information being broadcast can be received using the handheld device 2. The CPU 11 of each of the transmitters 1A to 1F executes the near field communication program; and implements a near field communication control unit 45 that controls the communication performed by the near field communication unit 16 illustrated in FIG. 2, and implements a facility information registering unit 46 that registers facility information such as the conference room names of the conference rooms A to F in the HDD 14.

Functions of Handheld Device

The CPU 21 of the handheld device 2 executes the reservation application and implements a near field communication control unit 51, a network communication control unit 52, a display control unit 53, and an input processing unit 54. The near field communication control unit 51 controls the near field communication unit 26 illustrated in FIG. 3, and controls the reception of the facility information broadcast from the transmitters 1A to 1F. The network communication control unit 52 controls the network communicating unit 27, which is illustrated in FIG. 3, and controls the network communication with the server device 3 for enabling confirmation of the reservation status and enabling making a reservation of the desired conference rooms.

The display control unit 53 controls the display of the reservation status, which is received from the server device 3, in the liquid crystal display 28. The input processing unit 54 processes the input information of the user as received via the operating unit 29.

Functions of Server Device

The CPU 31 of the server device 3 executes the reservation processing program and implements a network communication control unit 56, an availability-unavailability determining unit 57, and a registering unit 58. The network communication control unit 56 controls the communication of the network communicating unit 36, which is illustrated in FIG. 4, in such a way that network communication is performed with the handheld device 2. The availability-unavailability determining unit 57 refers to a usage status DB 4 based on the facility name received from the handheld device 2, and determines the time slots in which the concerned conference room is available. The registering unit 58 updates the usage status DB 4 by registering, in the usage status DB 4, the reservation information that is received from the handheld device 2 in response to sending, to the handheld device 2, the reservation status information that represents the determination result obtained by the availability-unavailability determining unit 57.

Meanwhile, in this example, the near field communication control unit 45, the facility information registering unit 46, the near field communication control unit 51, the network communication control unit 52, the display control unit 53, the input processing unit 54, the network communication control unit 56, the availability-unavailability determining unit 57, and the registering unit 58 are implemented using software. However, alternatively, some or all of those constituent elements can be implemented using hardware such as an integrated circuit (IC).

The near field communication program, the reservation application, and the reservation processing program can be recorded as installable files or executable files in a computer-readable recording medium such as a compact disk read only memory (CD-ROM) or a flexible disk (FD). Alternatively, the near field communication program, the reservation application, and the reservation processing program can be recorded in a computer-readable recording medium such as a compact disk recordable (CD-R), a digital versatile disk (DVD), a Blue-ray (registered trademark) disk, or a semiconductor memory. Still alternatively, the near field communication program, the reservation application, and the reservation processing program can be installed via a network such as the Internet or can be stored in advance in an internal ROM.

Registration of Facility Information

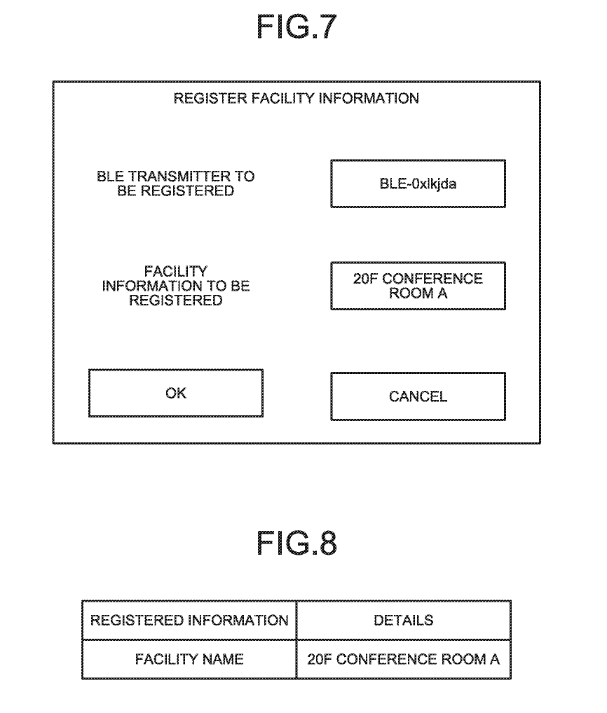

In this reservation processing system, before operating the reservation processing system, the facility information of the conference rooms A to F needs to be registered in the transmitters 1A to 1F, respectively, installed in the conference rooms A to F, respectively. FIG. 6 is a sequence diagram for explaining the operation of registering the facility information in the transmitters 1A to 1F. With reference to FIG. 6, firstly, the administrator of the reservation processing system operates the operating unit 29 of the handheld device 2 on a registration screen for facility information as illustrated in FIG. 7, and inputs a conference room name (in this example, “20F conference room A”) and a transmitter name (in this example, “BLE-Oxlkjda”) (Step S1).

Once such facility information is input (i.e., when an “OK” button illustrated in FIG. 7 is pressed), the CPU 21 of the handheld device 2 issues a facility information registration request to the transmitter that is currently accepting registration of facility information (in this example, the transmitter 1A installed in the conference room A) (Step S2). Then, in the transmitter 1A illustrated in FIG. 5, the facility information registering unit 46 registers the facility information, which is received from the handheld device 2, in the HDD 14. In FIG. 8 is illustrated an example of the facility information registered in the HDD 14. In the example illustrated in FIG. 8, it is indicated that the facility information “20F conference room A” is registered in the HDD 14 (Step S3). Herein, the near field communication control unit 45 of the transmitter 1A performs continuous broadcast or intermittent broadcast of the facility information “20F conference room A”.

Reservation Operation According to First Embodiment

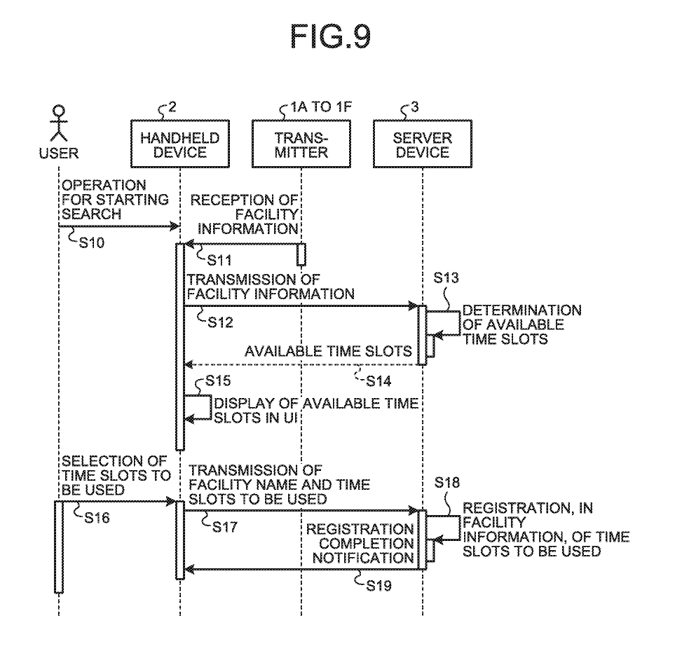

In this way, when the facility information is registered in each of the transmitters 1A to 1F of the conference rooms A to F, respectively; the transmitters 1A to 1F become able to broadcast the facility information corresponding to the conference rooms A to F, respectively. As a result, in the reservation processing system according to the first embodiment, it becomes possible to make a reservation of the desired conference room. FIG. 9 is a sequence diagram for explaining a flow of the reservation operation meant for making a reservation of the desired conference room in the reservation processing system according to the first embodiment.

With reference to FIG. 9, when the user operates a search button that is displayed in the display screen of the handheld device 2 and that is meant for instructing the start of a search for conference rooms (Step S10), the near field communication unit 26 of the handheld device 2 of the user starts the reception of facility information and receives the sets of facility information being broadcast from the transmitters in the conference rooms using near field communication (Step S11). Then, the handheld device 2 sends the sets of facility information, which are received from the transmitters, to the server device 3 via the network (Step S12). In the server device 3, the availability-unavailability determining unit 57 refers to the usage status DB 4 based on the facility information, such as “20F conference room A”, received from the handheld device 2 (i.e., the facility information indicating the conference room in which the user is currently present); and determines the time slots in which the user-specified conference room is available (Step S13). Subsequently, in the server device 3, the network communication control unit 56 controls the network communicating unit 36 in such a way that the information indicating the available time slots is sent to the handheld device 2 (Step S14).

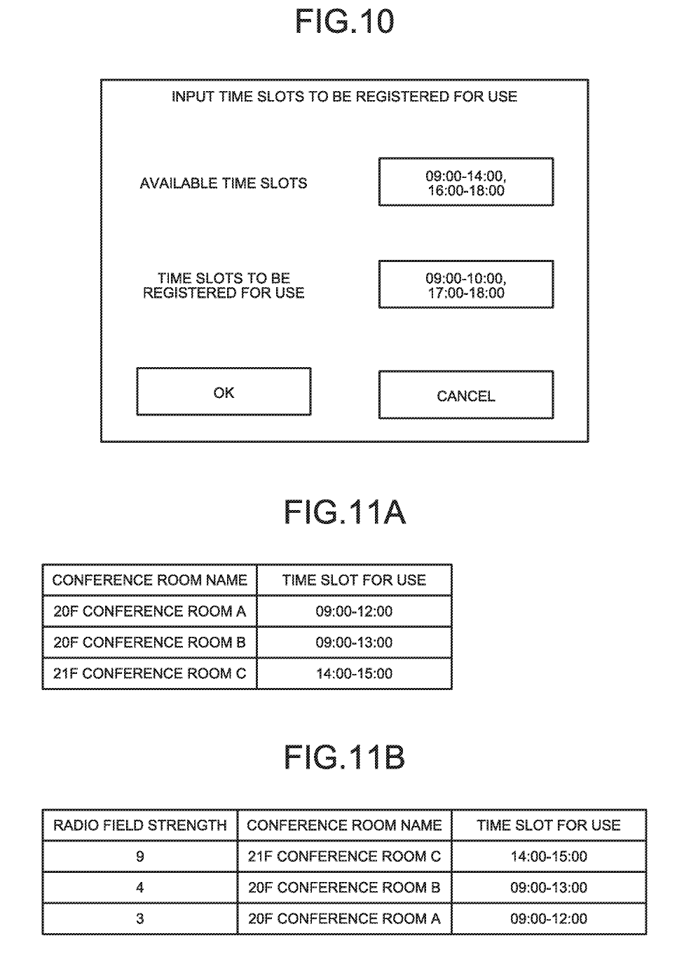

In the handheld device 2, based on the information indicating the available time slots as received from the server device 3, the display control unit 53 creates a usage registration screen regarding the concerned conference room and displays it in the liquid crystal display 28 (Step S15). Then, in the usage registration screen, the user inputs the time slots in which the conference room is to be used (Step S16). In FIG. 10 is illustrated an example of the usage registration screen. In the example illustrated in FIG. 10, the conference room specified in the facility information by the user is available in the time slot of “9:00 to 14:00” and the time slot of “16:00 to 18:00”; and the user specifies, as the time slots to be registered for use, the time slot of “9:00 to 10:00” and the time slot “17:00 to 18:00”.

In the example given above, the user operates the handheld device 2 and issues a request to start a search. Alternatively, a request for a list of conference rooms can be issued to the server device 3, and the available time slots for the conference room selected by the user from the list of conference rooms can be displayed in the handheld device 2.

The network communication control unit 56 of the handheld device 2 controls the network communication of the network communicating unit 27 in such a way that the information indicating the time slots to be registered for use as input by the user is sent to the server device 3 (Step S17). In the server device 3, based on the information indicating the time slots to be registered for use as sent from the handheld device 2 of the user via the network, the registering unit 58 updates the reservation status information in the usage status DB 4 (Step S18).

FIG. 11 is a diagram illustrating an example of the reservation status information registered in the usage status DB 4. As illustrated in FIG. 11A, in the usage status DB 4, each conference room name is registered in a corresponding manner to the information indicating the time slots reserved for use. In the server device 3, when the registration (updating) of the reservation status information in the usage status DB 4 is completed, the network communication control unit 56 controls the network communication of the network communicating unit 36 in such a way that a registration completion notification is sent to the handheld device 2 (Step S19). That marks the completion of the reservation for using the desired time slots in the desired conference room for the user.

Meanwhile, as illustrated in FIG. 11B, the network communication control unit 56 of the server device 3 can store the information in the usage status DB 4 in descending order of the radio field strengths (i.e., in ascending order of the distances) of the sets of facility information received from the conference rooms; and can provide the information to the handheld device 2. In the example illustrated in FIG. 11B, a “21F conference room C” has the highest radio field strength of “(level) 9”, and a “20F conference room B” has the second highest radio field strength of “(level) 4”. Thus, the facility information of the conference rooms can be listed in the handheld device 2 in descending order of the radio field strengths (i.e., in ascending order of the distances). Then, from among the listed conference rooms, the user can select, for example, the conference room having the shortest distance (i.e., the conference room having the highest radio field strength).

Operation for Selecting Desired Conference Room from Among a Plurality of Conference Rooms, and Making a Reservation

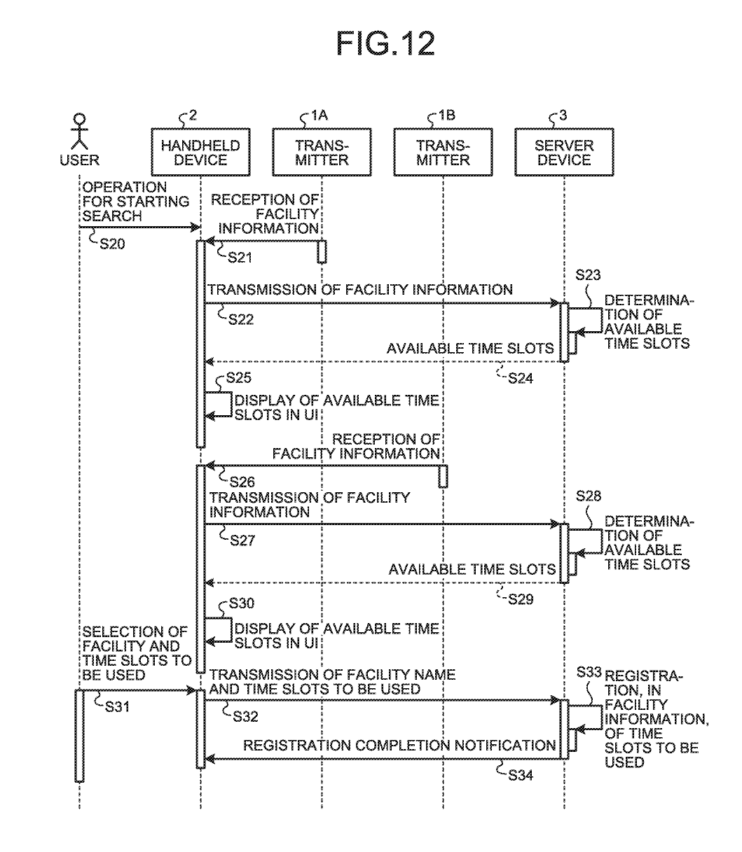

The explanation given till now is about an example in which the user makes a reservation of a conference room after moving close to it. Alternatively, the handheld device 2 can receive and list the sets of facility information from the transmitters of all conference rooms from which reception is possible at the current location of the user, and can display the usage status of the user-selected conference room in the liquid crystal display 37. FIG. 12 is a sequence diagram for explaining a flow of operations in which the sets of facility information from the transmitters of all conference rooms are received and listed; and the usage status of the user-selected conference room is displayed, and a reservation for that conference room is accepted. As illustrated in FIG. 12, when the user operates the search button that is displayed in the display screen of the handheld device 2 and that is meant for instructing the start of a search for conference rooms (Step S20), the handheld device 2 starts the reception of facility information.

When the facility information is received from the transmitter 1A of the conference room A (Step S21), the handheld device 2 transfers that facility information to the server device 3 (Step S22); obtains the information indicating the available time slots for the conference room A (Steps S23 and S24); and displays the time slots in the liquid crystal display 37 (Step S25).

Moreover, at the current location, along with receiving the facility information of the conference room A, if the facility information from the transmitter 1B of the conference room B is also received (Step S26); then the handheld device 2 transfers the facility information of the conference room B (Step S27), obtains the information indicating the available time slots for the conference room B (Steps S28 and S29), and displays the time slots in the liquid crystal display 37 (Step S30).

That is, in this example, the handheld device 2 receives all sets of facility information that are currently receivable from the conference rooms; and displays, in the liquid crystal display 37, the information indicating the available time slots for the conference rooms corresponding to the sets of facility information received from the server device 3. In this way, the handheld device 2 displays, in the liquid crystal display 37, a list of available time slots for each conference room.

Based on the listed usage status of the conference rooms, the user selects the time slots for the desired conference room and makes a reservation (Steps S31 to S34).

Meanwhile, regarding the reception of the sets of facility information of the conference rooms (Steps S21 and S26), the sets of facility information can be received either for a predetermined period of time or until the user selects a facility and the time slots at Step S31.

Meanwhile, at the time of listing the usage status of the conference rooms, from among the sets of facility information received from the conference rooms, the usage status list can be displayed for the sets of facility information corresponding to the radio field strengths equal to or greater than a predetermined threshold value. In that case, the displayed list includes the usage status of the conference rooms that are close to the current location of the user.

Moreover, the sets of facility information can be received from such conference rooms which are close to the location to which the user has moved, and the user status list can be displayed.

Moreover, after every predetermined period of time, the handheld device 2 can again receive the sets of facility information from the conference rooms and update the displayed list. As a result, the user status of the conference rooms from which the facility information is no more received (and the user status of the conference rooms for which the facility information reception strength becomes equal to or lower than a predetermined level) gets deleted from the list.

Meanwhile, if no facility information is received within a predetermined period of time, then the handheld device 2 can issue a request for obtaining the list of all conference rooms (facilities) stored in the server device 3.

In the example given above, the user operates the handheld device 2 and issues a request for starting a search. Alternatively, a request for obtaining the list of conference rooms can be issued to the server device 3; and the available time slots for the user-selected conference room, which is selected from the list of conference rooms displayed in the handheld device 2, can be displayed in the handheld device 2.

### Effect of First Embodiment

As is clear from the explanation given till now, in the reservation processing system according to the first embodiment, the usage status of the facilities that are close to the current location of the user can be learnt using near field communication. Hence, from among the facilities that are close to the current location of the user, the desired facility can be selected and a reservation can be made for that facility.

### Second Embodiment

Given below is the explanation of a reservation processing system according to a second embodiment. In the second embodiment, the explanation is given for an example in which there is restriction on the users who are allowed to make a reservation for each conference room. Herein, since that is the only differentiating point from the first embodiment, the following explanation is given only about that difference, and the redundant explanation is not given again.

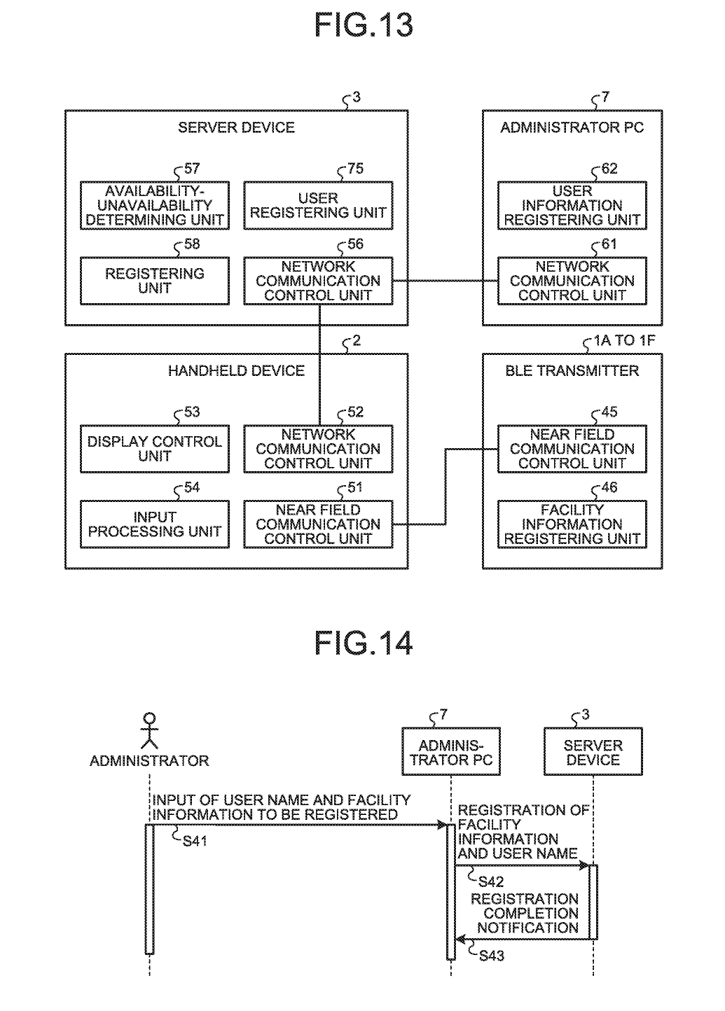

FIG. 13 is a diagram illustrating a software configuration of the reservation processing system according to the second embodiment. As illustrated in FIG. 13, in the reservation processing system according to the second embodiment, a network communication control unit 61 and a user information registering unit 62 are implemented when the CPU of the personal computer of the administrator (i.e., the CPU of an administrator PC) executes an administration program. Moreover, in the reservation processing system according to the second embodiment, the server device 3 includes a user registering unit 75 that is implemented as a result of executing the reservation processing program. Meanwhile, as already described, some or all of the network communication control unit 61, the user information registering unit 62, and the user registering unit 75 can be implemented using hardware.

In the reservation processing system according to the second embodiment, before operating the reservation processing system, each of the conference rooms A to F needs to be registered in the server device 3 in a corresponding manner to the users who are allowed to use that conference room. FIG. 14 is a sequence diagram for explaining the operation of registering each of the conference rooms A to F in a corresponding manner to the users who are allowed to use that conference room.

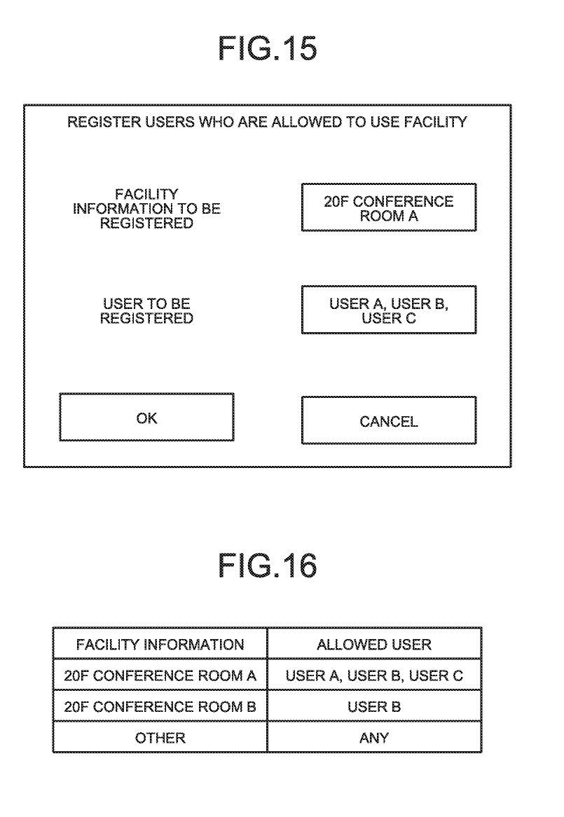

With reference to the sequence diagram illustrated in FIG. 14, the administrator boots an administrator PC 7 and operates it to display a user registration screen, and registers the allowed users for each facility (i.e., for each conference room) (Step S41). In FIG. 15 is illustrated an example of the user registration screen. In the example illustrated in FIG. 15, the administrator registers users A, B, and C as the users who are allowed to use the conference room A on the 20-th floor. In this way, when a facility (a conference room) and the names of the allowed users are registered, the user information registering unit 62 and the network communicating unit 61 of the administrator PC 7 send, to the server device 3, registration information indicating the input facility (the input conference room) and the names of the allowed users (Step S42).

The server device 3 registers, in the usage status DB 4, the names of the allowed users for each conference room (Step S43). In FIG. 16 is illustrated an example of registration in the usage status DB 4. In the example illustrated in FIG. 16, the users A, B, and C are registered as the users allowed to use the conference room A on the 20-th floor, and the user B is registered as the user allowed to use the conference room B on the 20-th floor. Moreover, with reference to FIG. 16, “Other” indicates all other conference rooms (the conference rooms other than the conference rooms A and B), and “Any” indicates that any user is allowed to use the other conference rooms.

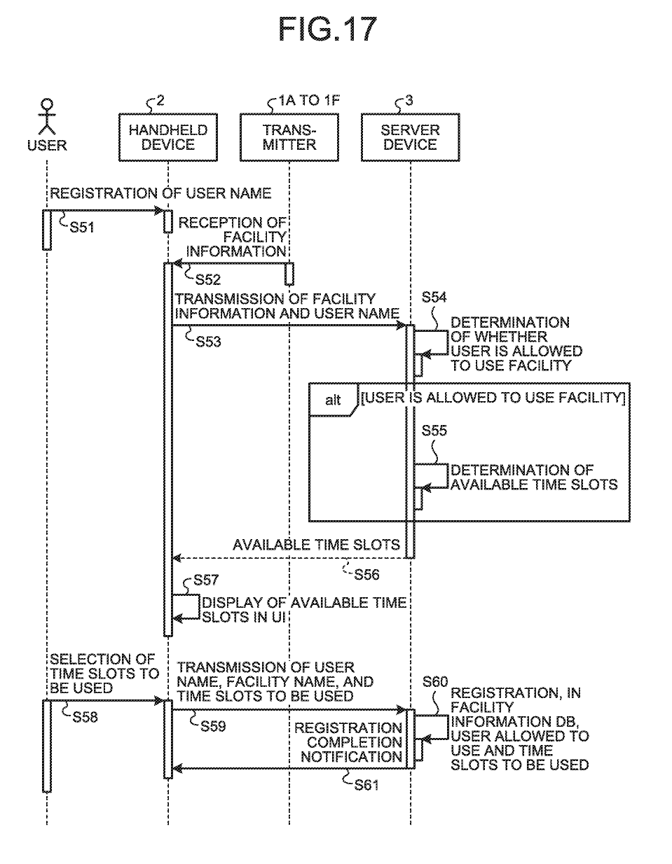

As a result of performing such user registration, reservation of a predetermined conference room can be made only by the users registered in advance. FIG. 17 is a sequence diagram for explaining a sequence of operations by which only the users registered in advance are allowed to make a reservation of a predetermined conference room. With reference to the sequence diagram illustrated in FIG. 17, a user registers his or her own name (or personal information such as identification information) in advance in the handheld device 2 (Step S51). In this state, when that user moves close to the conference room, his or her handheld device 2 receives the facility information being broadcast from the transmitter (Step S52).

Upon receiving the facility information, the network communication control unit 52 of the handheld device 2 sends the received facility information and the already-input user name to the server device 3 via the network (Step S53). In the server device 3, the availability-unavailability determining unit 57 refers to the usage status DB 4 based on the facility information and the user name received from the handheld device 2 of the user, and determines whether or not the user having the received user name is allowed to make a reservation for the conference room indicated by the facility information that is received from the handheld device 2 of the user (Step S54). If it is determined that the user is not allowed to make a reservation, then the availability-unavailability determining unit 57 sends an error message to the handheld device 2 via the network communicating control unit 56 for notifying that the reservation cannot be made.

On the other hand, if it is determined that the user having the received user name is allowed to make a reservation, then the availability-unavailability determining unit 57 refers to the usage status DB 4 and determines the available time slots (Step S55), and notifies the handheld device 2 of the user about the available time slots via the network communication control unit 56 (Step S56).

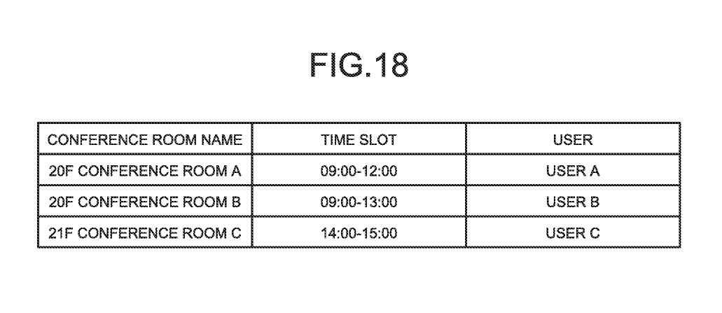

In the handheld device 2 of the user, the display control unit 53 displays the available time slots, which are received from the server device 3, in the liquid crystal display 37 (Step S57). Then, the user selects the desired time slots from among the available time slots displayed in the liquid crystal display 37, and operates the operating unit 38 to send the selected time slots to the server device 3 (Step S58). Upon detecting that sending operation, the network communication control unit 52 of the handheld device 2 sends the information indicating the user-selected time slots and the user name to the server device 3 via the network (Step S59). Subsequently, as illustrated in FIG. 18, the server device 3 registers the user name and the reserved time slots, which are sent by the user, in the usage status DB 4 in a corresponding manner to the conference room specified for reservation (Step S60), and sends a registration completion notification to the handheld device 2 (Step S61).

Meanwhile, as far as the “information indicating the user-selected time slots” is concerned, the information indicating the reserved time slots can be sent to the server device 3, or identification information such as numbers enabling identification of the reserved time slots can be sent to the server device 3. Alternatively, the information indicating the starting date and time and the information indicating the reservation period, such as 30 minutes, one hour, or two hours, can be sent in combination to the server device 3.

### Effect of Second Embodiment

In the reservation processing system according to the second embodiment, in addition to achieving the effects as achieved in the first embodiment, only the users who are registered in advance can be allowed to make a reservation for using the conference rooms.

Lastly, the embodiments described above are only exemplary, and the scope of the present invention is not limited by the embodiments described above. For example, the configuration can be such that the information indicating the available time slots is obtained only from the facilities falling under the sites registered in advance in the handheld device 2, and the reservation is made accordingly. In that case, the facility information broadcast from the transmitters of the facilities contains site information.

According to the embodiments, it becomes possible to perform a reservation operation with respect to the facilities present close to the current location of the user.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An information processing system comprising at least a transmitter; a server device; and a handheld device, wherein
the transmitter is installed in a facility for which a reservation for use is to be made, and performs continuous transmission or intermittent transmission of facility information that at least contains identification information enabling facility identification,
the handheld device includes a first processor configured to execute
receiving the facility information from the transmitter using first-type communication,
sending the facility information, which is received using the first-type communication, to the server device using second-type communication that is different than the first-type communication,
receiving reservation status information that is sent by the server device in response to transmission of the facility information and that indicates time slot in which a reservation is possible for facility specified in the facility information,
controlling display of the reservation status information, which is received from the server device, in a display unit, and
sending reservation information, which indicates a reserved time slot that is selected based on the reservation status information, to the server device using the second-type communication, and
the server device includes a second processor configured to execute
referring to a memory unit used to store reservation status of each facility and accordingly determining time slot in which a reservation is possible for facility corresponding to the facility information received from the handheld device,
controlling storage of information indicating the reserved time slot, which is received from the handheld device, in the memory unit,
sending, in response to reception of the facility information from the handheld device using the second-type communication, the reservation status information, and
receiving the reservation information from the handheld device.

2. The information processing system according to claim 1, wherein
in the memory unit of the server device, user information of a user allowed to make a reservation is stored in a corresponding manner to each facility,
the first processor of the handheld device sends the facility information and the user information to the server device,
the second processor of the server device refers to the memory unit and determines whether or not the user information received from the handheld device is stored in a corresponding manner to facility specified in the facility information received from the handheld device, and
when the second processor determines that the user information received from the handheld device is stored in a corresponding manner to the facility specified in the facility information received from the handheld device, the second processor of the server device sends, to the handheld device, the reservation status information of the facility specified in the facility information received from the handheld device.

3. The information processing system according to claim 1, wherein
the first-type communication represents near field communication, and
the second-type communication represents predetermined network communication.

4. An information processing device comprising a processor configured to execute:
receiving facility information, which at least contains identification information enabling facility identification, using first-type communication from a transmitter, which is installed in a facility for which a reservation for use is to be made and which performs continuous transmission or intermittent transmission of the facility information;
sending the facility information, which is received using the first-type communication, to a server device using second-type communication that is different than the first-type communication;
receiving reservation status information which is sent by the server device in response to transmission of the facility information and which indicates time slot in which a reservation is possible for facility specified in the facility information;
controlling display of the reservation status information, which is received from the server device, in a display unit; and
sending reservation information, which indicates a reserved time slot that is selected based on the reservation status information, to the server device using the second-type communication, and accordingly making a reservation for desired time slot of desired facility.

5. An information processing method performed by an information processing device that includes a processor, the method comprising:
receiving facility information, which at least contains identification information enabling facility identification, using first-type communication from a transmitter, which is installed in a facility for which a reservation for use is to be made and which performs continuous transmission or intermittent transmission of the facility information;
sending the facility information, which is received using the first-type communication, to a server device using second-type communication that is different than the first-type communication;
receiving reservation status information that is sent by the server device in response to transmission of the facility information and that indicates time slot in which a reservation is possible for facility specified in the facility information;
controlling display of the reservation status information, which is received from the server device, in a display unit; and
sending reservation information, which indicates a reserved time slot that is selected based on the reservation status information, to the server device using the second-type communication, and accordingly making reservation for desired time slot of desired facility.
